(19) United States
(12) Patent Application Publication
(10) Pub. No.: US 2009/0327715 A1
(43) Pub. Date: Dec. 31, 2009

(54) System and Method for Cryptographic Identification of Interchangeable Parts

(76) Inventors: Kevin W. Smith, Coral Gables, FL (US); Thomas Bales, Coral Gables, FL (US); Derek Dee Deville, Miami, FL (US); Carlos Rivera, Cooper City, FL (US); Matthew A. Palmer, Miami, FL (US)

Correspondence Address: MAYBACK & HOFFMAN, P.A., 5722 S. FLAMINGO ROAD #232, FORT LAUDERDALE, FL, 33330, US

(21) Appl. No.: 12/114,287

(22) Filed: May 2, 2008

Related U.S. Application Data
(60) Provisional application No. 60/927,556, filed on May 4, 2007.
(60) Provisional application No. 60/946,512, filed on Jun. 27, 2007.

(51) Int. Cl. G06F 21/00

(52) U.S. Cl. 713/168

(57) ABSTRACT

An anti-counterfeiting identification system for a medical tubing system, including a tubing assembly having upstream and downstream tubing portions removably connected to one another in a mechanically coupled state and a mechanically uncoupled state. The mechanically coupled state is a reliable fluid tight connection of the upstream and downstream portions for fluids passing there through from the upstream portion to the downstream portion. A two-part encrypted identification assembly has a first part connected to the upstream portion and a second part connected to the downstream portion. The first and second parts are electrically connected only through one lead and ground and are electrically connected to one another only in the mechanically coupled state. Also provided are methods for identification, anti-piracy, and inventory.

### CROSS-REFERENCE TO RELATED APPLICATION

This application claims the benefit under 35 U.S.C. § 119(e) of U.S. Provisional Application No. 60/927,556 filed May 4, 2007, and U.S. Provisional Application No. 60/946,512 filed Jun. 27, 2007, the complete disclosures of which are hereby incorporated by reference herein in its entirety.

### FIELD OF THE INVENTION

The present invention lies in the field of electronic communication and identification of devices and, more particularly, to automatic encrypted identification protocols between devices that are physically coupled together.

### BACKGROUND OF THE INVENTION

Identification of parts is a desirable attribute in many applications. One exemplary prior art identification device employs radio-frequency and is referred to as a Radio-Frequency Identification Device (“RFID”). In an exemplary embodiment where a device uses re-loadable or interchangeable cartridges, an RFID transponder can be placed at the cartridge and be measured by the device when placed therein or close thereto to ensure compatibility with the device. In such a configuration, the RFID reader interrogates the RFID mounted in the cartridge. The RFID responds with a code that the device verifies. If the cartridge is labeled as verified, the device becomes active and ready for use. If the cartridge is rejected, however, the device gives a rejected indication and can be disabled for non-use with the rejected cartridge. RFIDs, however, have drawbacks because the readers are expensive, the antennas are required to be relatively large, and the distance for reading is relatively close, typically measured in centimeters.

Other wireless authentication measures can be employed, for example, active RFIDs or infrared (IR) transmission devices. However, both of these require a source of electrical power at the transponder end, which is a cost and size disadvantage.

Encrypting the identification of a device would be beneficial so that, among other things, potential counterfeiters cannot determine the identification of a particular part. With encryption, however, comes the need for processing numbers and, associated with such calculations, is the use of processing chips (e.g., a microprocessor), one of which would have to be placed on the part to be identified. If encryption is used in this manner, a power source would be needed—which is, as set forth above, undesirable because it adds cost and, most likely, weight. Further, such a power source would take up space that is not available or, if available, may be needed for other features.

It would, therefore, be desirable to provide an identification system and method that does not require a source of power at the receiving end and that employs encryption so that identification can be ensured and neither corrupted nor copied.

It would also be desirable to provide the identification system and method with a memory storage so that additional information can be exchanged or transmitted between the identified object and the device using the object or another interrogation device.

### SUMMARY OF THE INVENTION

The invention overcomes the above-noted and other deficiencies of the prior art by providing systems and methods for cryptographic identification of interchangeable parts. The present invention also provides systems and methods for identifying a disposable and/or reusable device with encryption.

Numbering with unique encrypted identifiers can be applied to many devices and processes. For example, where a system has a removable and/or interchangeable part, it is beneficial to track usage of such a part and/or to track inventory of that part. If the system is expanded to have the numbering device include a memory (for example, some form of random access memory (RAM)), then that memory can be used to store various attributes or characteristics of the part or how it was or is to be used.

According to the present invention, power is supplied to the encrypted identifier through an already existing power supply contained within the interface device used to communicate with the identifier. So that supply of power is insured at all times, the present invention provides a definite and positive connection between the supply of power and the identifier.

The present invention applies a sufficiently small identifier to minimize the size of the identifier. The identifier is also set at a per-unit manufacturing cost to allow it to be disposable. Finally, connections between the encrypting identifier and the corresponding reader device are minimized to a single lead.

Some exemplary procedures in which the encrypted identification system and method of the present invention can be used include inventory, regional coding, anti-counterfeiting, prevention of re-use, and tracking. There are many other uses for the system and method in various different technology areas.

The present invention, according to certain embodiments, is an anti-counterfeiting interchangeable part identification system that includes a power supply, an identification interface device coupled to said power supply and interchangeably receiving at least one of a set of removable parts, said identification interface device having a 1-wire communication and power interface electrically connected to said power supply, and an encryption device to be disposed on each one of said set of removable parts and powered solely by said power supply when electrically connected to said identification interface device, said identification interface device and said encryption device being electrically connected only through one lead and ground when a respective one of said set of removable parts is removably connected to said identification interface device, said one lead being a communication and power connection directly connected to said power interface when said encryption device on one of the set of parts is reliably mechanically connected to said identification interface device.

The present invention, according to another embodiment, is an anti-counterfeiting identification system for a medical tubing system that includes a tubing assembly with an upstream tubing portion and a downstream tubing portion removably connected to said upstream tubing portion in a mechanically coupled state and a mechanically uncoupled state, said mechanically coupled state being a reliable fluid-tight connection of said upstream and downstream portions for fluids passing through said portions from said upstream tubing portion to said downstream tubing portion. The system also includes a two-part encrypted identification assembly having a first part connected to said upstream portion and a second part connected to said downstream tubing portion, said first part and said second parts being electrically connected only through one lead and ground and being electrically connected to one another only when said mechanically coupled state occurs.

The two-part encrypted identification assembly, according to another feature, is operable to perform an encrypted authentication of at least one of said upstream and downstream tubing portions on said one lead when said mechanically coupled state occurs.

According to yet another feature of the present invention, the first and second parts are reliably electrically connected through only one lead and ground only during an establishment of said reliable fluid-tight connection between said upstream and downstream portions.

The present invention, according to another embodiment, is a self-authenticating tubing set ensuring that two pieces of the set are reliably connected together and includes a tubing set having at least first and second tubing parts, said first tubing part having a coupler and said second tubing part having a receiver removably interlocking with said coupler, a first electronic encrypted communication chip at said receiver, a power supply connected to electrical ground and to said first electronic encrypted communication chip to provide electrical power thereto, a second electronic encrypted communication chip at said coupler, said receiver having an electrically insulated communications lead connected to a communications port of said first electronic encrypted communication chip and to the electrical ground, said second electronic encrypted communication chip having a grounding port connected to the electrical ground when said coupler and said receiver are reliably connected together, and a communications port electrically insulated from said coupler, said communications port being conductively connected to said electrically insulated communications lead when said coupler and said receiver are reliably connected together. The first electronic encrypted communication chip and the second electronic encrypted communication chip is operable to exchange encrypted data there between only when the coupler and the receiver are reliably connected together.

The present invention, according to another embodiment, is

In accordance with another embodiment, the present invention provides a method for improving security of interchangeable parts from counterfeiting and includes the steps of storing encrypted unique identification data in each one of a set of 1-wire encryption devices, physically coupling a different one of the 1-wire encryption devices to each one of a plurality of interchangeable parts to be inventoried, thereby associating a particular identification data to each of the parts, and making a reliable mechanical connection between at least one of the parts to be inventoried and an encryption reader and, only upon an existence of the reliable mechanical connection, creating a reliable electrical connection between the encryption device associated with the part and an encrypted communication device of the encryption reader, reading the encrypted unique identification data associated with the part with the encryption reader, and determining an acceptance state of the part dependent upon the encrypted unique identification data read.

In accordance with an additional embodiment, the present invention provides a method for preventing an end user from using unauthorized parts and includes the steps of supplying interchangeable parts with an encrypted identification tag, making a reliable mechanical connection between one of the parts and an encryption reading device to, thereby, create a reliable electrical connection between the encryption reading device and the encrypted identification tag, authenticating the part with the encryption reading device dependent upon encrypted identification data associated with the part, and either permitting a use of the part if authentication is positive or prohibiting a use of the part if authentication is negative.

In accordance with yet another feature, the present invention includes the steps of supplying the interchangeable parts with a number of different groups of encrypted identification tags, each of the groups being associated with one of a number of different keys, providing reading devices and associating one of the keys to each of the reading devices, coupling one of the interchangeable parts with one of the reading devices, and enabling use of the coupled one of the reading devices if the particular key of the coupled one of the interchangeable parts is authenticated by the one of the reading devices.

Other features that are considered as characteristic for the invention are set forth in the appended claims.

Although the invention is illustrated and described herein as embodied in systems and methods for cryptographic identification of interchangeable parts, they are, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

Advantages of embodiments of the present invention will be apparent from the following detailed description of the preferred embodiments thereof, which description should be considered in conjunction with the accompanying drawings in which:

FIG. 1 is a diagrammatic illustration of an inventory control area for the systems and methods according to the invention;

FIG. 2 is a is a schematic circuit diagram of an exemplary encryption circuit for interchangeable parts according to the invention;

FIG. 3 is a fragmentary, diagrammatic illustration of an exemplary medical tubing set with the encrypted identification device of the present invention; and

FIG. 4 is a process flow chart illustrating a process for improving security of interchangeable parts from counterfeiting according to an embodiment of the present invention.

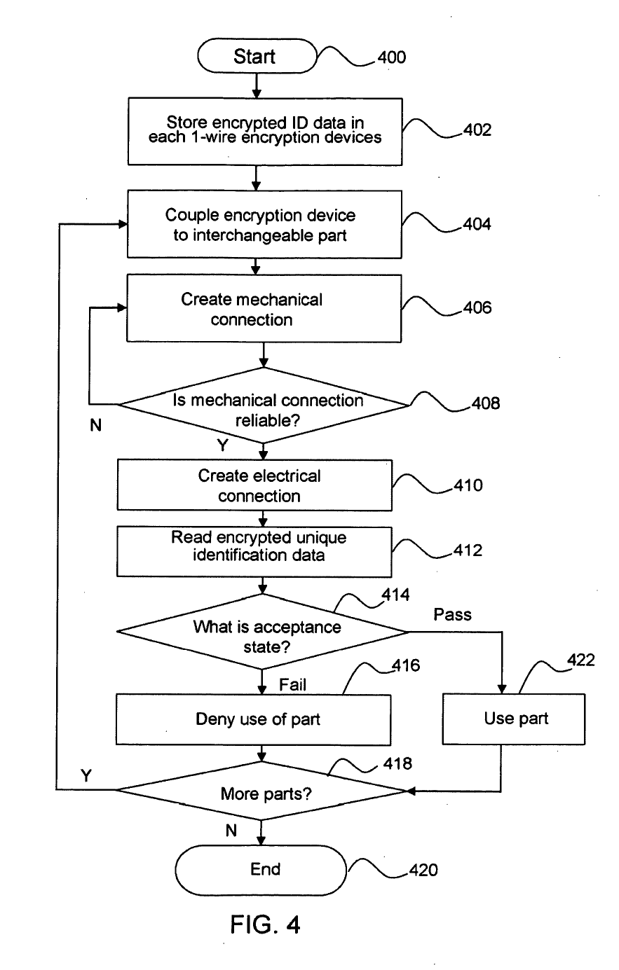

### DETAILED DESCRIPTION OF THE INVENTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. It must be noted that, as used in the specification and the appended claims, the singular forms “a,” “an,” and “the” include plural references unless the context clearly dictates otherwise.

While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Devices for encrypted identification are commercially available. One of such encryption devices is produced by Dallas Semiconductor and is referred to as the DS2432 chip. The DS2432 chip not only provides encrypted identification between a reader and a transponder, but it also has a memory that can be used to store device-specific information, which information and its uses can be applied to novel technologies that will be described in further detail below.

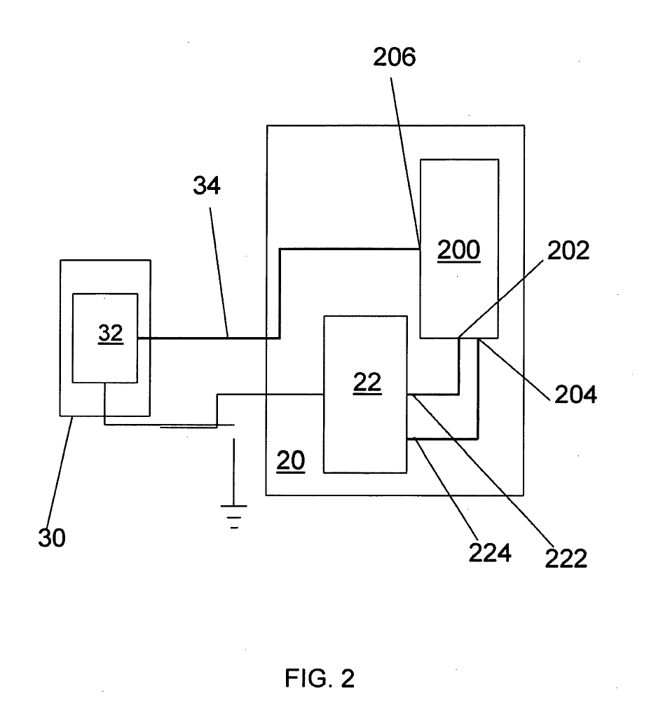

One beneficial characteristic of the DS2432 is that it is a 1-wire device. This means that the power and both of the input and output signals travel on the same line. With a 1-wire device such as the DS2432, only one electrical lead is needed to traverse the distance from the external communication device to the resident encrypted identification device to make a direct connection between the two. In addition to this one wire, an electrical ground reference connection is also required. The DS2432 is also only a few square millimeters in area, making the chip easy to install on a small interchangeable part, while simultaneously satisfying the minimal size requirement. To keep all communication with the DS2432 chip hidden from outside examination, a DS2460 (also manufactured by Dallas Semiconductor) can be used to perform a comparison of an encrypted transmission received from a DS2432 with an expected result calculated internally. The characteristics of both of these chips are explained, for example, by Dallas Semiconductors' Application Note 3675, which is hereby incorporated by reference herein in its entirety. The DS2432 chip is relatively inexpensive. The DS2460 chip costs significantly more than the DS2432 chip, but is still inexpensive enough to be thrown away after use. There exists an alternative circuit configuration using two DS2432 chips that is explained in FIG. 2 of Application Note 3675, which circuit eliminates the need of the more expensive DS2460 chip by performing the comparison with a local microprocessor (e.g., microprocessor 200). In such a configuration, the cost for adding encryption into the device 1 is reduced (when a microprocessor 200 is already present), however, as explained, the configuration gives up some aspects of security by making available to inspection both numbers that are to be compared. For all of these enumerated reasons, use of the DS2432 and/or the DS2460 provides advantages of minimal electrical connection and correspondingly reduced manufacture cost.

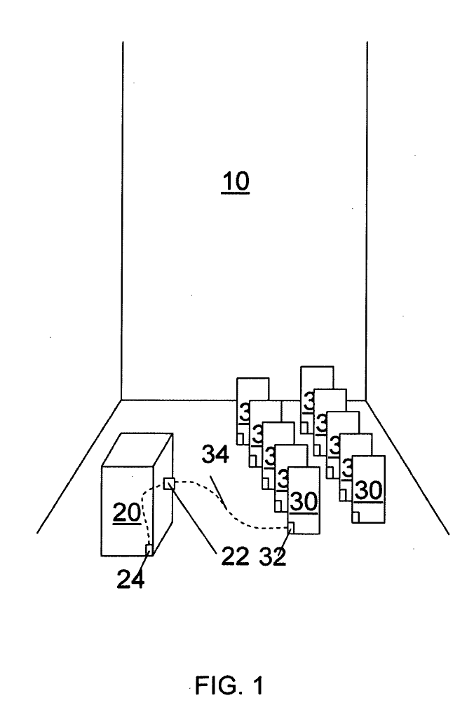

Referring now to the figures of the drawings in detail and first, particularly to FIG. 1 thereof, there is shown an exemplary simplified illustration for such a connection when used with a process for inventory of a given part within a storage area or inventory station 10. More particularly, a reader 20 is provided at an inventory station 10 at which an inventory of parts 30 is stored. As a given part 30 is placed within the storage area 10, the reader 20 is constructed and/or programmed to carry out a receive operation—in which operation a part 30 (or a group of parts 30) is (are) desired to be placed into the inventory of the storage area 10 for later retrieval—for example, by pressing a “receive into inventory” button. The reader 20 is provided with a direct connection 22 at which the part 30 is secured removably so that communication between the reader 20 and the encrypted identifier 32 disposed on the part 30 can occur. If, for example, the exterior of the connection 22 is grounded and an interior conductive portion is insulated from the exterior and is electrically connected from an encryption reader 24 to the 1-wire communication lead 34 of the encrypted identifier 32 (depicted in FIG. 1 as a dashed line), then 1-wire communication can be effected when the part 30 is secured to the connection 22. By carrying out the place-into-storage routine, a unique identifier of the part 30 to be stored is processed and any desired information is exchanged between the reader 20 and the memory of the encrypted identifier 32, for example, date, time, prior storage identifying information, shipment/transfer information, and/or storage area identifying information. As used herein, an “inventory” is not limited to the exemplary use where a part is placed into and is taken out from a storage location. Inventory also includes any kind of tracking process that determines which parts are valid for a given use and which are not valid. Inventory also includes keeping track of the kinds of use that can be made by a given part. Other exemplary kinds of inventory will be described herein.

As a given part 30 is desired to be removed from the storage area 10, the reader 20 is constructed and/or programmed to carry out a remove operation—in which operation one of the stored parts 30 is desired to be removed from the inventory of the storage area 10 for use or transfer—for example, by pressing a “remove from inventory” button. The part 30 (or parts 30) is (are) secured to the connection 22 of the reader 20 and the appropriate remove-from-storage communication between the reader 20 and the encrypted identifier 32 disposed on the part 30 occurs. As the remove-from-storage routine occurs, the unique identifier of the part 30 to be removed is processed and any desired information is exchanged between the reader 20 and the memory of the encrypted identifier 32, for example, date, time, prior storage identifying information, shipment/transfer information, and/or storage area identifying information.

One exemplary encryption circuit configuration of the present invention places a first encrypted identifier 32 (such as the DS2432 encryption chip) on the part 30 to be identified. Ground for the indicator 32 is electrically connected to a metallic portion of the part 30 which, in turn, is electrically connected to ground of the reader 20 when secured thereto through the connection 22. Any form of a metallic ground lead can be used on the part 30 for making the electrically grounding contact. For example, if the part 30 has a metallic outer frame, the ground lead of the DS2432 chip can be electrically connected to the outer frame of the part 30. Likewise, the 1-wire connection of the indicator 32 is electrically connected to a contact pad that is somewhere on the part 30 but is electrically insulated from ground. The encryption reader 24 is provided with the appropriate electronics for communicating with the indicator 32 on the part 30 (uni-directionally or bi-directionally). For example, the encryption reader 24 can be supplied with one of the DS2460 chips and each part 30 can be provided with one of the DS2432 chips. A single electrically conductive but insulated lead 34 is connected from the DS2460 at the reader 20 to the part 30 (or to another device, e.g., microprocessor 200, for relay of communication data).

An exemplary process for electronically verifying the identity of the part 30 using encryption is described with an embodiment having one DS2432 chip and one DS2460 chip. An exemplary control circuit for the encryption device is shown in FIG. 2. The process is described using the inventory system of FIG. 1 but is not limited thereto. The reader 20 contains therein an electronic assembly, for example, a circuit board with a microprocessor 200. One I/O pin 202 of the microprocessor 200 is connected to a first lead 222 of the DS2460 and another I/O pin 204 is connected to a second lead 224. Each part 30 is provided with a corresponding DS2432 chip 32 and the 1-wire lead 34 is connected to a third I/O pin 206 of the microprocessor 200. It is noted that appropriate programming can allow the three exemplary pins 202, 204, 206 indicated herein to be less than three in an alternative embodiment.

To start the communication process, a part 30 is connected to the reader 20, making corresponding electrical contact with ground and with the 1-wire lead 34. When the microprocessor 200 detects that a part 30 has been connected to the device 1, it can be caused to run an authentication routine. The microprocessor 200 initiates a random number request to the DS2460 over the first communication pin 202. The DS2460 has a pre-programmed secret number that is the same as the pre-programmed secret numbers stored in each of the DS2432 chips contained on the parts 30 to be inventoried. Therefore, when the same random number is provided to both the DS2432 and the DS2460 chips, the output result from each of the two chips will be identical. The DS2460 generates a random number and supplies it, via the second pin 204, to the microprocessor 200 for forwarding, via pin 206, on to the DS2432 over the 1-wire lead 34. Alternatively, the microprocessor 200 may generate the random number internally through hardware, software, or a combination of both, and supply it to the DS2432 and DS2460 chips. A unique code is read from the DS2432 by the microprocessor and communicated to the DS2460. When the DS2432 receives the random number, it applies its SHA-1 algorithm (developed by the National Institute of Standards and Technology (NIST)) and its unique code and internally stored secret information to cryptographically generate a hash code reply. This hash code reply is transmitted back over the 1-wire lead 34 to the microprocessor 200 and is forwarded (through either pin 202 or pin 204) to the DS2460. During this period of time, the DS2460 is also calculating its own a hash code reply from the information supplied to it and its internally stored secret information. First, the DS2460 internally applies the same random number sent to the DS2432 and the other data provided to it to its own SHA-1 algorithm and stores, internally, the generated hash code reply. The DS2460 also stores the hash code reply transmitted from the DS2432 through the microprocessor 200. Both of the hash code replies are compared and, if they are identical, an acceptance state is entered and the interchangeable part 30 is confirmed as authenticated. If there is a difference between the hash code replies, then the part 30 is rejected and a rejection indicator at the reader 20 is activated to notify a user of that rejected state. The rejection indicator can provide whatever information that is desired and its configuration is dependent upon the specific process that is used or the result to be obtained (see examples below). For example, data regarding the time, date, environment, etc. and characteristics of the unauthenticated part 30 can be stored for later or simultaneous transmission to the manufacturer (or its agent) to inform the manufacturer, for example, that the user is attempting to store or remove an unauthorized part 30. It is noted at this point that the lack of encryption in the messages communicated between the reader 20 and the part 30 would allow the authentication messages to be intercepted and counterfeit, pirated, or unauthorized parts 30 could be used without having to purchase the parts 30 from an authorized distributor, for example.

In the exemplary encryption embodiment described herein, the only information that is transmitted across lines that can be examined is a single random number, the unique code of the DS2432, and a single hash code reply, but none of the secret information. It is understood that it would take hundreds of years to decrypt this SHA-1-generated reply, thus reducing any incentive for reverse engineering.

Because the chips used in this example each have secure memories that can only be accessed after authentication occurs, they can be programmed to employ multiple secret keys each stored within the memory. For example, if the DS2460 has multiple keys stored therein and the parts 30 each have only one key selected from this stored set of multiple keys, the DS2460 can act as a “master” key to each of the set of “specific” keys associated with the parts 30. In such an embodiment, the different keys can have versions and the DS2460 can be used to accept, reject, acknowledge, and/or take various actions dependent upon the version of the part 30 connected to the reader 20, which version depends upon the particular key received from the part 30.

By authenticating the part 30 as described herein, many positive results are obtained. One beneficial attribute is that the instrument manufacturer can prevent a user from using unauthorized parts, thereby insuring use of only authorized parts (which can be referred to as an “authorization inventory”). Not only does this guarantee that the manufacturer can receive royalties from sales of the part, but it also allows the manufacture to insure that the quality of the parts is known.

Having the encryption circuitry contain memory dramatically enhances the benefits provided by the present invention. For example, if a single device can receive a number of interchangeable parts, three for example, then each of the three different interchangeable parts could be provided with an individualized key and the reader can be programmed to store and use each of these three keys. Upon receiving a hash code reply that corresponds to one, but not the other two internally calculated hash code replies, the reader would know what kind of part has been attached to the reader (which can be referred to as an “identification inventory”). Each part could also contain in its memory device-specific parameters, such as time, date, temperature, and any other desired device-related parameter. This information can cause a device in which the part is used to behave differently dependent upon the kind of part detected (which can be referred to as a “behavior inventory”). As indicated above, the parameters examined can even account for revision levels in the particular part in a “revision inventory.” For example, a first-revision part could have certain parameters for use and, by detecting that particular part, programming could cause the device to not allow use of first-revision parts but allow use of second-revision parts, or vice-versa, or to behave differently for each part. By having memory available at the part and/or at the reader, other part-relevant parameters could be stored, for example, duration of each use, speed of each use, physical parameters existing at each use, and/or imparted forces experienced during each use.

Having memory on the encryption chips can also allow the part to keep track of other kinds of data. For example, the part can store the identity of each device to which it was connected, the identity of the device that was connected to the part (at any time in the past), the time, date and other temporal data when use and/or connection occurred, how long it was connected, what occurred with the part when it was connected, and many other similar parameters. (This can be referred to as a “use inventory”). One parameter in particular could record data when misuse or error occurs. This would allow any reviewing entity (for example, a manufacturer) to determine if the part was faulty or if a user caused the error, for example, the latter being investigated to assist the user with remedial measures or other training to prevent future similar occurrences. If the memory is supplied with manufacturer-specific information, such as “built by machine # ______,” “final test performed by operator # ______,” or “inspected by operator # ______ on [date],” then forensic determination of errors can be made easier to detect, trace, and repair. All of this information can easily be stored within the memory for use in a “fault inventory.”

With regard to preserving integrity of the data in the memory, the memory could be powered for years merely by including one or more power cells in the part and, in instances where such power cells are already present, by connecting the memory device to the power cell(s). Alternatively, the memory may be of a non-volatile type (for example, Flash RAM) which does not require power to be maintained. In such a case, longevity of stored data could be ensured. The memory can be used to store all uses of a particular part, along with relevant calendar data. For example, if a part is only certified for use within a short time span after the use begins (a “time-based inventory”), but the part already has recorded data indicating that it was used at different times greater than the permitted time span, then, when the part was finally returned to the reviewing entity for recycling or other processing, the reviewer could detect that the user was improperly and, possibly, unsafely, using the part. This process can be referred to as a “date-stamp inventory” or a “safety inventory.”

Where parameters external to the memory are to be measured and stored, appropriately configured sensors can be added to any portion of the part, to the device on which the part is placed, or to the reader. For example, temperature sensors can transmit ambient temperature existing when the part was used. This temperature reading can be used to determine if an undesirable subsequent event occurred due to improper temperature control existing during the use (e.g., in countries where air-conditioning is not available). With appropriate heat-resistant components and at least one temperature sensor, information regarding the duration, maximum temperature, and the temperature curve can be stored in the memory when the device having the memory is being sterilized. Accordingly, if the measured duration and/or temperature is not above set minimums, then the part can be rejected from further use until proper sterilization of the part occurs.

In the unlikely event that the part becomes inoperable during use, any state of the part can be recorded utilizing the memory on these encryption identifiers. Furthermore, data indicating why inoperability occurred could be stored for later investigation. For quality assurance, when such an event is detected, the part can be programmed to indicate that a certified letter should be sent to the customer/user informing them of the improper use (referred to as a “notification inventory”).

One of the areas of technology that encrypted identification of interchangeable parts is medical devices. The following text illustrates various medical embodiments where encrypted identification according to the present invention provides significant benefits.

The field of endoscopy utilizes different devices intended to pass through and operate with a working channel of the endoscope. If each of such channel devices is equipped with a first encrypted identification device and the scope is also provided with a second encrypted identification device, then secured communication between the two devices becomes possible. For example, an endoscope can be programmed to indicate whether a particular channel device is permitted for use with the endoscope in an “interoperability inventory.” The inside surface of each working channel can be incorporated with two electrically conductive parts, for example, two rings separated from one another at a longitudinal distance or a single ring having two parts isolated from one another. If one of the parts is electrically grounded and the other is electrically connected to the encrypted identification part, then the two identification parts can be made to communicate with one another through these leads each time the channel device is used with the endoscope. One exemplary device could physically block the channels with a movable intermediate wall contained at an intermediate position within the working channel of the scope. In this embodiment, the conductive leads for communication are disposed upstream of the wall at a defined distance. The channel device would be equipped with two similarly disposed leads at a distance from the distal end of the channel device, the distance being equal to the defined distance between the blocking wall and the communication and grounding parts within the channel. As such, when the channel device is inserted to touch the blocking wall, the corresponding leads are connected to complete the ground and the communication circuit. Authentication can immediately occur and, if authentication is positive, the blocking wall can be removed for endoscope use, for example, for a given period of time, at which the blocking wall is biased to close off the working channel again. If the channel device is still within the channel, the wall will be held open until the channel device is moved to a position proximal of the wall. It is noted here that grounding contact can be made with an outer grounded surface of the channel device and a grounded inner channel surface, and the communication contact can be an electrically insulated ring at a given distance from the blocking wall. As such, only one contact is needed on the channel device for the 1-wire communication.

When the authentication is being carried out, any of the herein-mentioned data transfers can occur. For example, if the entity that controls the endoscope wishes to know the identity of every device that is inserted through any of the working channels, then the unique identifier of every channel device can be stored within the memory of the encryption device located at the scope. The date, time, duration, and any other parameter associated with that channel device can be recorded along with the identification information. Accordingly, when the scope is returned to a reviewing entity, then that entity can examine the stored data and determine if the scope was used with non-permitted channel devices, or if the permitted use of the scope was greater than for a predefined time period. (This process can be referred to as a “monitoring inventory.”)

The above-mentioned uses for an endoscope apply equally to all other medical devices having working channels through which different and various channel devices are inserted. For example, they apply to flexible endoscopes, rigid endoscopes, trocars, cystoscopes, and ureteroscopes, to name a few.

Another area of technology in which the encrypted identifier can be used is associated with capital equipment that is re-used with disposable parts. For example, if a particular piece of equipment interfaces with a disposable tubing set, then the identifier can be associated with each of the tubing sets. In use, the equipment and/or the reader at the inventory storage area can interface with the identifier. Being re-usable, both the equipment and the reader can be configured with a significant amount of storage memory. Therefore, both or either can store the encrypted identifications of every part that can be used with that equipment/reader. Further, like pieces of equipment can be networked in a way to transmit use of any part at any time throughout the entire network. Thus, if a given identifier is read for a second time (whether by the same piece of equipment or a different one), the equipment/reader can reject that part as unusable. In a patient treatment context, such a system will eliminate the ability to re-use a given part from one patient to another patient or from using the same part on the same patient at times that are too close together or too far apart from one another. Further, the memory can store characteristics of the part, which include the time of use and in which piece of equipment the particular part can be used. If the part must be used within a given time period, the reader can store a timestamp in the memory of the part as it is being removed from the inventory. When the part is placed within the piece of equipment for use, a second timestamp can be written to the part and compared with the first or the equipment can simply read the first timestamp and compare it with a resident current time (which can be self-generated or supplied from an external network). If the difference in the two timestamps is greater than a pre-set period, the part can be rejected as “old” and, therefore, rendered unusable without any physical change to the part.

One particular embodiment can include radio-frequency or ultrasonic generators. These devices typically require use of a removable pail that can only be used with a single patient (this is true for many reasons, one of which is infection control/hygiene). The generator, which can be in the form of a handle, is envisioned to be used many times and with many patients. As such, it is, typically, not disposable and has a power supply that connects to an electric mains or is self-contained, such as a battery pack. The disposable, patient-contacting distal effector is removably inserted onto the generator and a medical procedure is conducted on the patient. Before permitting such use, however, the encrypted identification communication between the two encryption devices must occur. Initially, the generator can be supplied with information regarding the type of disposable part that is attached thereto and can confirm that such a part is authorized for use with that generator. Any data can, then, be transferred between the part and the generator before, during, and/or after the procedure occurs. Any parameter can be recorded, such as the time the procedure started/ended, the ambient conditions surrounding the part/generator, the duration of use, etc. After the procedure ends, if the user fails to remove and dispose/recycle/return the part, the generator can also signal the user that the part must be removed before another procedure can be started. Also, the generator can transmit to a central facility the identity of the part used, so that no other generator can use that part again.

Such security for part use is not limited to this exemplary embodiment and can be used in many different areas, for example, with physiologic monitoring of anesthesia or medication. With a device that is configured to administer fluids (e.g., crystalloids and/or colloids), the fluid container and the device for holding the fluid container can be configured to each have one part of the two-part encrypted identification system of the present invention, for example. With each different fluid container having a unique identifier and by programming the container holder to only accept those fluids that have been prescribed to the particular patient by a physician, the system and process can be used as a last-resort safety device for preventing improper administration of any fluid (IV or medicine) to that patient. Additionally, and/or alternatively, if there is a fluid that should not be administered to a patient (for example, because of a patient's allergy), then any number of those non-permitted fluids can be programmed into the memory of the container holder. Because the encrypted identifier device is so small, the identifiers can be used even with containers as small as syringes, which are routinely attached to entry ports of an IV assembly. By adding an encrypted identity reader to a clip that holds such a syringe, and with appropriate programming of the reader when the reader is “assigned” to a patient during that patient's stay in the facility (e.g., hospital, clinic), if the syringe is connected to the reader before administering the medication, the reader can indicate to the user in any way (visually, mechanically, aurally) that the particular syringe is permitted or not permitted for use with that patient.

The inventive system and process is not limited to merely encrypted authentication of use. It can also be used for ensuring proper mechanical use and/or insuring a proper mechanical connection. As set forth above, the encrypted identifier can be used with a disposable tubing set, for example. When associating the novel encryption system of the present invention with such equipment, an important synergy results from combining the encrypted confirmation of authorized parts with the mechanical connection device of the tubing set and its receiver.

Before discussing the advantages achieved with the inventive system, it is believed that a short description of a prior art RFID (electro-magnetic) identification system would be beneficial. Colder Products Company (a Dover Company) manufactures RFID-enabled couplings with electronics that measure and identify critical parameters. The IDENTIQUIK™ series of couplings utilize RFID technology to automatically identify fluid characteristics and capture data from point-of-origin to point of use. A male coupling having an RFID antenna is inserted into a female receiver. When the antenna is in the electro-magnetic field generated by the receiver, a circuit is coupled and indicates to the user that the part is operable. Then, when the male portion is sufficiently far inside the female opening of the receiver, a mechanical tab can be inserted into a groove of the male portion and, thereby, removably secure the couple to the receiver. The electro-magnetic coupling occurs at a distance well before securing of the parts occurs.

Because the configuration of the prior art system relies on electro-magnetic fields, there is an inherent drawback to this system, which poses significant security risks. All that is necessary to electronically indicate that the plug is coupled correctly to the receiver is the existence of a coupling between the antenna on the plug and the receiver. Such coupling is omni-directional and can easily be defeated simply by placing a plug with the appropriate communications antenna next to a receiver, for example, fastened with adhesive tape. Because the plug's antenna is within the inquiry field generated by the receiver when so coupled, the connection-detection equipment of such a system will allow the component to function—even though no plug is actually present within the receiver. Not only can this safety feature be defeated easily, it can also be defeated in a way that permits the user to utilize unauthorized plugs manufactured by entities other than an authorized manufacturer. Similarly, such a weakness can allow a situation where the user employs an already used plug in another medical procedure, and possibly with another patient. Not only is this dangerous from the plug quality-control standpoint, it is also dangerous and, potentially fatal, because it allows the possibility of inter-mixing bodily fluids. Such a compromise in safety during use of the equipment eviscerates all beneficial functionality of the prior art system. Therefore, it would be desirable to supply a configuration that cannot be defeated by the user.

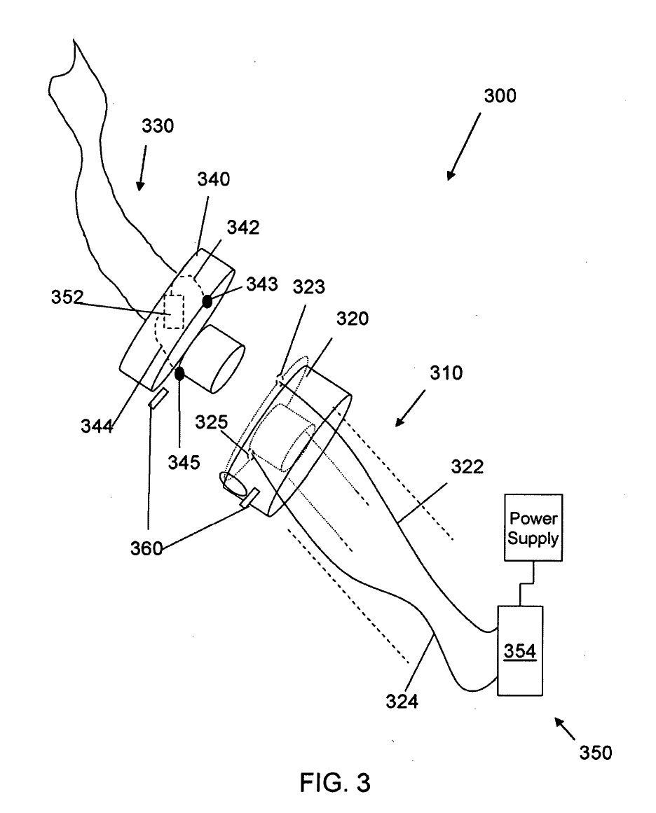

The invention supplies a system and method that cannot be defeated by the user. The invention takes advantage of the 1-wire technology to implement a configuration that ensures a reliable and positive mechanical connection every time the electrical connection is made. Then, through this reliable connection, the encrypted authentication is carried out to ensure that the part attached thereto is authorized for use, among other things. Simply put, the authentication feature is inextricably connected to the mechanical connection to prevent the former if the latter is not established. With reference to FIG. 3, a tube set 300 comprised of an upstream portion 310 having a first coupling part 320 (in this exemplary case, a receiver) and a downstream portion 330 having a second coupling part 340 (in this exemplary case, a couple). In the above-mentioned prior art, a coupling is inserted into a receiver and a lock secures the coupling thereat. If that tube set provides electro-magnetic coupling, for example, the coupling has an electro-magnetic antenna and the receiver has a corresponding transceiver such that proximity of the electro-magnetic antenna with the transceiver indicates to a control unit that the coupling device is secure and that fluid can be permitted to flow therethrough. However, if the user has taken a separate second coupling and has placed or fastened it next to the receiver, then the electro-magnetic coupling is made but the mechanical connection is either not made or is made with a non-authorized additional coupling. Either of these situations is to be avoided because the manufacturer wants the system to only operate with authorized and non-counterfeit parts and because the user must have the tubing set perform without error.

In contrast, the inventive tube set 300 provides the downstream portion 330 with a first part 352 of the encryption system 350 and the upstream portion 310 with a second part 354 of the encryption system 350. For example, the first part 352 can be an identifier and the second part 354 can be a reader. More specifically, the first part 352 can be a DS2432 chip and the second part 354 can be either a microprocessor chip or the DS2460 chip. As set forth above, the identifier 352 of the 1-wire inventive system only needs electrical ground 342 and a single communications wire 344 for bi-directional communication.

As can be seen in FIG. 3, ground 342 can be effected in a first exemplary embodiment using a wire that is attached to a grounding pad 343 (both of which are electrically isolated from the body of the couple 340. The receiver 320 can be likewise provided with a corresponding grounding pad 323 and ground wire 322 (also electrically isolated from the body of the receiver 320). Thus, when the coupling 340 is first connected to the receiver 320, the two grounding pads 323, 343 are electrically isolated from one another. However, when the coupling 340 is properly connected to the receiver 320, the two grounding pads 323, 343 physically contact to complete ground. A retention device 360 that secures the couple 340 to the receiver 320 (e.g., a clasp, bayonet mount, snap fit, or any other kind of removable closure) can be formed to only lock the parts together when the grounding pads 323, 343 are in physical contact with one another. Correspondingly, I-wire communication can be effected by electrically connecting 344 the 1-wire port of the first part 352 to a communication pad 345 such that the electrical connection is electrically isolated from the body of the couple 340. Like the couple 340, the receiver 320 can be provided with a corresponding communication pad 325 and communication wire 324 (both electrically isolated from the body of the receiver 320). Thus, when the couple 340 is first connected to the receiver 320, the two communication pads 325, 345 are electrically isolated from one another. However, when the couple 340 is properly connected to the receiver 320, the two communication pads 325, 345 physically contact to complete the 1-wire communications circuit. The pad configuration forming the ground and communication leads (323-343; 325-345) is only one possible embodiment for creating the positive electrical connection of the present invention. Another possible embodiment can include a pin and socket assembly, the pin extending from either the receiver 320 or the couple 340 to enter into the socket and form an electrically conducting connection between the two parts 320, 340. Any other equivalent connection measures are also contemplated.

In an alternative configuration, ground can be made by electrically isolating the downstream communications pad 345 from the remainder of the couple 340 and by electrically isolating the upstream communications pad 325 from the remainder of the receiver 320. Then, the entire body of the couple 340 and receiver 320 are grounded. In such a configuration, only one electrical contact needs to be made across the gap that exists between the two pails 320, 340. Thus, if the location of the electrical communications connection (e.g., 325, 345) is positioned to only allow positive connection of the communications circuit when the mechanical connection is in the fixed state, it is not possible to have a closed communications circuit without also having a correct and satisfactory mechanical connection. Here, the same act of connecting the two parts of the fluid connection makes the electrical connection.

In this exemplary configuration, three orientations of the tubing connector can be defined between a non-latched position and the latched position. In the non-latched position, there is no electrical connection of the communications circuit and there is no mechanical connection of the couple. In the latched, secured, or use position, both a positive electrical connection and a secure mechanical connection exist. Also present is an intermediate position, referred to as a meta-stable position, where a not-mechanically-latched-but-electrically-connected condition exists. The mechanical configuration of the couple 340 and the receiver 320 is formed to prevent a user from keeping the parts in the meta-stable position and to force it away from this meta-stable position until it is physically placed in the latched position by the user. One exemplary configuration for forcing the parts away from the meta-stable position is through the use of a bias device (e.g., a spring) that automatically prevents retention of the parts in the meta-stable position. It is noted that parts of a medical tubing set must confidently remain in the stable position during use because a non-reliable tubing set could mean death of a patient caused, for example, by a user thinking that the patient was being given a fluid (e.g., anesthesia) but that fluid was actually not being administered if the connection was leaking and, therefore, the patient was being given less than a desired amount of fluid, or the connection is entirely open to the environment and no fluid is being administered to the patient. In either case, drastic consequences could ensue during a medical procedure. With the present invention, it is not possible to make the fluid connection without also simultaneously making the electrical connection. While it is possible for the electrical connection to be made just before the mechanical connection exists, the security device will prevent the parts from forming the electrical connection up to and until the mechanical connection is reliably made. As used herein, “reliable” or “reliably”, when used with the mechanical connection of the two-part tubing set, is a state where the tubing set is fluidically coupled together to permit substantially unimpeded flow between the upstream and downstream lumens without leakage to the environment at the connection region therebetween and such that no external force is needed to keep the fluidic couple connected and where an external force is needed to uncouple the two portions, and, when used with the electrical connection of the two-part tubing set, is a state where the electrical connection areas are conductively connected and remain so by the mechanical connection without an external force being needed to keep the conductive connection together.

While the prior art system can be easily defeated by connecting a second couple to the side of the receiver, the invention cannot be either counterfeited or defeated because the mechanical connection and the communications circuit are made from the same feature. Both must be connected to allow the part to work and, if a valid encrypted response is not received after contact, then the part will not be identified as allowable for use.

It is noted that the couple and the receiver mentioned and illustrated herein are only exemplary embodiments. The features can be reversed or changed in any way to form a connection between a downstream part of a tubing system and its upstream part.

The present invention can also be used to assist with routine maintenance of capital equipment. If, for example, the equipment must be serviced after a given number of parts are used with the equipment, then the memory within the inventive system can store that ever-increasing number and display a “service” message to the user after the number is met or exceeded. The display can take any form at the equipment or can even be an electronically generated message that is sent, for example, over the Internet to a service provider.

The present invention can ensure that proper procedures are followed if the equipment is able to use, manipulate, or otherwise perform an operation with more than one part. For example, if the equipment is able to interact with many different kinds of parts, each of which performing a different function, then it would be beneficial to have the equipment know, with certainty, the kind of part the user is attempting to employ with the equipment at a given time. If each of the different parts is given a unique encrypted identifier that must be authenticated, then the equipment can be caused to operate in a part-specific way after such authentication occurs. Further, the equipment can be caused to instruct the user to a particular set of part-specific steps for proper use. More specifically, when one of the many different parts are connected to the equipment, flags are downloaded into the equipment, which flags correspond to a particular instruction set for use or warning to the user to take certain precautions, or even to prevent use if the part is of a version that is no longer compatible with the equipment. The flags can be associated with country or regional codes to prevent use of a given region's parts in another different region.

It is possible that the same kind of capital equipment resides in different kinds of locations. For example, the same piece of equipment can be placed in a general use hospital as well as in a pediatric hospital. It is self-evident that disposable parts that are to be used with these two pieces of equipment will be different because the latter is in a place where only parts associated with pediatric applications should be used. Accordingly, the equipment can have the same interface for receipt/connection with the part but the encrypted unique identifier within the equipment can allow the pediatric equipment to prevent any use of non-pediatric parts (at least without entry of a manual override (for example, where the child is as large as an adult or in an emergency where an adult is being treated by the pediatric hospital). More specifically, both pieces of equipment can store the identity of all parts that have the ability to be connected to either. However, after the latter piece of equipment is assigned to a pediatric hospital, it can be programmed with an identifier that prevents use of any parts that have identities corresponding to non-pediatric parts. The parts can be individually labeled as “adult only,” “pediatric only,” or “both,” for example. In such a case, the pediatric equipment would prevent use of the parts designated as “adult only” and would allow use of parts designated with “pediatric only” and “both.” This example is not the only possible safety process provided by the systems and methods of the present invention. The encrypted labeling of parts can be patient-specific, for example, male/female or critical care/non-critical care. Also, the encrypted labeling of parts can be medicine-specific, e.g., the parts can have an emergency room variant, an obstetrics/gynecology variant, or an orthopedic variant, to name a few. The systems and methods of the present invention allow for any possible distinguishing characteristics of the parts to be used.

The encrypted identification of the parts is not limited to the question of “use or not to use?” or insuring proper mechanical connection. Once a part is attached to a particular piece of equipment, that part can have identifying information used to control operation of the equipment because the system of the invention has a memory capacity. For example, if the equipment is able to supply fluids in the form of pressurized air, vacuum, or saline through the same connector, then the part to be attached to the connector can store the information that will cause the equipment to supply the correct fluid. By allowing the part to have this use-based information, it is the part that controls operation of the equipment and not a person, which eliminates human decision making and, thereby, ensures that no supply errors occur.

It is also possible to create a part that has various operating modes or has different features that can be controlled merely by using the encrypted identification feature of the present invention. For example, a particular probe can be manufactured to detect one of three different substances, the control of each test being separate from one another. More specifically, the part can be sold to a user to carry out any number of these operations and the encrypted identifier can be used to prevent the part from carrying out the non-purchased feature. In particular, a part that is authorized to perform only one of the three tests can be sold to a user at $X. The part that can perform two tests can be sold for $2X and for $3X where the part can perform all three tests. All parts actually sent to the user, however, have the ability to perform all three tests but, where only one test is purchased, the encrypted identifier is programmed accordingly and, when used by the purchaser, only provides a single test result. This allows the seller of parts to provide various priced devices in the same package, the different devices being activated merely with programming the memory.

Any of the above-mentioned exemplary embodiments can employ the encrypted identification system and method of the present invention to prevent use or inventory of counterfeit parts. This is similarly true for preventing re-use of parts that are only designed or authorized to be used once or only for a particular number of uses. If the unique identification number of a given part has already been registered as having been used, then inventory into or out from storage can be prevented as well as use with an associated device that has been informed of identifications that are no longer valid (e.g., by connecting the device to a reader and storing all used part numbers in the device). Improper use of a part or device can be stored, tracked, and/or transmitted, simultaneous with such use or thereafter. Remedial measures can be taken to prevent such uses by collecting relevant data associate with that improper use. When associated with an inventory process, the serial number and/or the lot control number can be used. A history of all parts entering into the inventory or exiting from the inventory can be stored and analyzed, for example, to assist with an entity's desire to keep a given number of parts on-hand. The memory of each part can also be stored with a “use before” date. Thus, the inventory system can prevent use of “older” parts before “younger” parts, or can merely identify to a user that the part has exceeded its “use before” date and, therefore, must be returned, recycled, or destroyed.

It is known that various devices, such as medical devices, have country or regional codes. There are various reasons for having such codes, for example, to prevent grey market goods. Having these country/regional codes stored in the memory, and making that memory accessible only through an encrypted key, can lead to the accurate tracking of such grey market goods. Another reason why regional codes are used is because of the different measuring systems employed in the different regions (e.g., metric and English units). By storing the regional code and reviewing the code before permitting use, potential errors can be eliminated and counterfeiters can be identified.

Most medical devices are single use—they are disposed after one medical procedure. Because the cost for the encrypted identification system and method of the present invention is relatively low (as compared to a typical medical device), it can be used along with disposable devices.

The process for improving security of interchangeable parts from counterfeiting begins at step 400 and moves directly to step 402 where encrypted unique identification data is stored in each one of a set of 1-wire encryption devices. In step 404, one of the 1-wire encryption devices is physically coupled to each one of a plurality of interchangeable parts to be inventoried, thereby associating a particular identification data to each of the parts. In step 406, a mechanical connection is made between at least one of the parts to be inventoried and an encryption reader. In step 408, a check is performed to determine if the mechanical connection is reliable. If the answer is no, the flow moves back to step 406 where another attempt is made to connect the components. The flow moves to step 410 only if the answer to step 408 is yes.

In step 410, a reliable electrical connection is made between the encryption device associated with the part and an encrypted communication device of the encryption reader. The encrypted unique identification data associated with the part is read by the encryption reader in step 412. In step 414, an acceptance state of the part is determined, where the acceptance state is dependent upon the encrypted unique identification data read. If the acceptance state is positive, the flow moves to step 422 and the use of the part is granted. Alternatively, if the acceptance state is negative, use of the part is denied in step 416 and the flow moves to step 418 where a check is made as to whether there are additional parts. If the answer is no, the process moves to step 420 and the process ends. If the answer to step 418 is yes, the flow moves back up to step 404 and repeats the making, creating, reading and determining steps for at least one more part.

The foregoing description and accompanying drawings illustrate the principles, preferred embodiments and modes of operation of the invention. More specifically, the encrypted identification systems and methods according to the present invention have been described with respect to an inventory system and process. However, the invention should not be construed as being limited to the particular embodiments discussed above. Additional variations of the embodiments discussed above will be appreciated by those skilled in the art as well as for applications, unrelated to inventory, that require encrypted identification of parts.

The above-described embodiments should be regarded as illustrative rather than restrictive. Accordingly, it should be appreciated that variations to those embodiments can be made by those skilled in the art without departing from the scope of the invention as defined by the following claims.

We claim:

1. An anti-counterfeiting interchangeable part identification system, comprising:
a power supply;
an identification interface device coupled to said power supply and interchangeably receiving at least one of a set of removable parts, said identification interface device having a 1-wire communication and power interface electrically connected to said power supply; and
an encryption device to be disposed on each one of said set of removable parts and powered solely by said power supply when electrically connected to said identification interface device, said identification interface device and said encryption device being electrically connected only through one lead and ground when a respective one of said set of removable parts is removably connected to said identification interface device, said one lead being a communication and power connection directly connected to said power interface when said encryption device on one of the set of parts is reliably mechanically connected to said identification interface device.

2. The system according to claim 1, wherein said power supply is integral with said identification interface.

3. The system according to claim 2, wherein said power supply is a battery pack.

4. The system according to claim 3, wherein said battery pack is removable.

5. The system according to claim 1, wherein said power supply is an electric mains.

6. The system according to claim 1, wherein said encryption device has a memory storing identification data about a respective one of said parts.

7. The system according to claim 1, wherein said encryption device is one of a Dallas Semiconductor DS2432 chip and a Dallas Semiconductor DS2460 chip.

8. An anti-counterfeiting identification system for a medical tubing system, comprising:
a tubing assembly having:
an upstream tubing portion; and
a downstream tubing portion removably connected to said upstream tubing portion in a mechanically coupled state and a mechanically uncoupled state, said mechanically coupled state being a reliable fluid-tight connection of said upstream and downstream portions for fluids passing through said portions from said upstream tubing portion to said downstream tubing portion; and
a two-part encrypted identification assembly having a first part connected to said upstream portion and a second part connected to said downstream tubing portion, said first part and said second parts being electrically connected only through one lead and ground and being electrically connected to one another only when said mechanically coupled state occurs.

9. The anti-counterfeiting identification system according to claim 8, wherein:
the two-part encrypted identification assembly is operable to perform an encrypted authentication of at least one of said upstream and downstream tubing portions on said one lead when said mechanically coupled state occurs.

10. The anti-counterfeiting identification system according to claim 8, wherein:
said mechanically coupled state occurs only when an electrical connection is made through said one lead and said ground.

11. The anti-counterfeiting identification system according to claim 8, wherein:
said first and second parts are reliably electrically connected through only one lead and ground only during an establishment of said reliable fluid-tight connection between said upstream and downstream portions.

12. A self-authenticating tubing set ensuring that two pieces of the set are reliably connected together, comprising:
a tubing set having at least first and second tubing parts, said first tubing part having a coupler and said second tubing part having a receiver removably interlocking with said coupler;
a first electronic encrypted communication chip at said receiver;
a power supply connected to electrical ground and to said first electronic encrypted communication chip to provide electrical power thereto;
a second electronic encrypted communication chip at said coupler;
said receiver having an electrically insulated communications lead connected to a communications port of said first electronic encrypted communication chip and to the electrical ground;
said second electronic encrypted communication chip having:
a grounding port connected to the electrical ground when said coupler and said receiver are reliably connected together; and
a communications port electrically insulated from said coupler, said communications port being conductively connected to said electrically insulated communications lead when said coupler and said receiver are reliably connected together; and
said first electronic encrypted communication chip and said second electronic encrypted communication chip operable to exchange encrypted data therebetween only when said coupler and said receiver are reliably connected together.

13. A method for improving security of interchangeable parts from counterfeiting, the method comprising:
storing encrypted unique identification data in each one of a set of 1-wire encryption devices;
physically coupling a different one of the 1-wire encryption devices to each one of a plurality of interchangeable parts to be inventoried, thereby associating a particular identification data to each of the parts; and
making a reliable mechanical connection between at least one of the parts to be inventoried and an encryption reader and, only upon an existence of the reliable mechanical connection:
creating a reliable electrical connection between the encryption device associated with the part and an encrypted communication device of the encryption reader;
reading the encrypted unique identification data associated with the part with the encryption reader; and
determining an acceptance state of the part dependent upon the encrypted unique identification data read.

14. The method according to claim 13, which further comprises, repeating the making, creating, reading and determining steps for at least one more part.

15. A method for preventing an end user from using unauthorized parts, which comprises:
supplying interchangeable parts with an encrypted identification tag;
making a reliable mechanical connection between one of the parts and an encryption reading device to, thereby, create a reliable electrical connection between the encryption reading device and the encrypted identification tag;
authenticating the part with the encryption reading device dependent upon encrypted identification data associated with the part; and
one of:
permitting a use of the part if authentication is positive; and
prohibiting a use of the part if authentication is negative.

16. The method according to claim 15, which further comprises:
supplying the interchangeable parts with a number of different groups of encrypted identification tags, each of the groups being associated with one of a number of different keys;
providing reading devices and associating one of the keys to each of the reading devices;
coupling one of the interchangeable parts with one of the reading devices; and
enabling use of the coupled one of the reading devices if the particular key of the coupled one of the interchangeable parts is authenticated by the one of the reading devices.

17. The method according to claim 16, which further comprises:
storing data within the encrypted identification tag prior to use; and
changing the stored data the encrypted identification tag during use of the part.

18. The method according to claim 17, wherein the stored data includes manufacturer-specific information.

19. The method according to claim 18, wherein the manufacturer-specific information includes at least one of:
“built by machine number” data;
“final test performed by” data;
“inspected by operator on date” data; and
“use by” data.

20. The method according to claim 19, which further comprises, prior to use of the part, determining whether or not a “time of use” is contained within a “use by” date of the stored data and permitting use of the part if the “time of use” is contained within a “use by” date or prohibiting use of the part if the “time of use” is outside the “use by” date.

21. The method according to claim 15, which further comprises:
using the part and recording data with the tag during use; and
detecting whether or not a user properly used the part by examining the tag after use and determining if the part use:
was used within a “use by” date; and
was used with an authorized device.

22. The method according to claim 15, which further comprises:
sensing at least one physical parameter of an environment of the part before use of the part; and
permitting use of the part dependent upon a result of the physical parameter sensed.

23. The method according to claim 15, which further comprises:
using the part and recording data with the tag during use; and
subsequently determining if the part use was authorized dependent upon the recorded data.

24. The method according to claim 23, wherein the stored data includes at least one of:
time of use;
date of use;
temperature of environment around part at time of use;
duration of use;
speed of use;
physical parameters existing during use;
imparted forces experienced during use;
how the part was connected to the encryption reading device;
what occurred with the part when it was connected to the encryption reading device; and
whether misuse or error occurred during use.

25. The method according to claim 24, which further comprises examining the used part to determine, based upon the stored data, at least one of:
whether or not the part was faulty; and
whether or not user error occurred and, if so, supplying the user with remedial measures or training to prevent future similar occurrences.

26. The method according to claim 15, which further comprises:
using the part and storing data within the identification tag during use; and
supplying the stored data to the encryption reading device after use of the part.

27. The method according to claim 26, wherein the stored data includes at least one of:
time of use;
date of use;
temperature of environment around part at time of use;
duration of use;
speed of use;
physical parameters existing during use;
imparted forces experienced during use;
how the part was connected to the encryption reading device;
what occurred with the part when it was connected to the reading device; and
whether misuse or error occurred during use.

28. The method according to claim 26, which further comprises examining the used part to determine, based upon the stored data, at least one of:
whether or not the part was faulty; and
whether or not user error occurred and, if so, supplying the user with remedial measures or training to prevent future similar occurrences.
